(19) United States
(12) Patent Application Publication
(10) Pub. No.: US 2024/0160546 A1
(43) Pub. Date: May 16, 2024

(54) Optimization of Process for Exiting Machines from Test Environments

(71) Applicant: International Business Machines Corporation, Armonk, NY (US)

(72) Inventors: Christopher Mazile, Brooklyn, NY (US); Ali Y. Duale, Poughkeepsie, NY (US); Marc Henri Coq, Hopewell Junction, NY (US)

(21) Appl. No.: 17/988,011

(22) Filed: Nov. 16, 2022

(51) Int. Cl. G06F 11/273

(52) U.S. Cl. CPC G06F 11/2733

(57) ABSTRACT

Mechanisms are provided for assigning at least one operator to a break team to break a machine from a test environment. The mechanisms, in response to installing a machine under test (MUT) in a test environment, generate a MUT data structure in a MUT database that stores machine detail data. The mechanisms monitor the testing process to detect the testing process nearing completion and, in response to nearing completion, the mechanisms: (1) execute a first computer model on the MUT data structure to prioritize breaking of the MUT from the test environment; (2) execute a second computer model on operator data in an operator database to identify eligibility operators for the break team; and (3) generate an output specifying the break team in association with the MUT and a priority for breaking the MUT from the test environment based on the execution of the first and second computer models.

### BACKGROUND

The present application relates generally to an improved data processing apparatus and method and more specifically to an improved computing tool and improved computing tool operations/functionality for optimizing the process for exiting machines from test environments.

With machine manufacturing, it is important that the manufactured machines be tested to ensure that they operate properly before being deployed for use. This is the case with any complex machine, especially in the case of complex computing devices, such as mainframe server racks, having a plurality of individual server computing devices that may work in concert with one another, complex control systems for controlling a plurality of other systems, such as in the case of computer control units for automobiles, aircraft, or other vehicles, and the like. Such testing requires that the manufactured machines be physically connected, via hard wiring, to appropriate test computing systems via a testing cell. A test team of human subject matter experts must then administer, via manual or semi-automatic processes, various tests on the hardware and/or software of the manufactured machine, collect data from the tests of the machines, analyze the data to determine that the machine is operating correctly or within acceptable limits, such as with regard to performance and reliability criteria, and then, exit the machine from the test cell or testing environment.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method, executed in a data processing system, is provided for assigning at least one operator to a break team to break a machine from a test environment. The computer-implemented method comprises generating, in response to installing a machine under test (MUT) in a test environment, a MUT data structure in a MUT database that stores machine detail data corresponding to the MUT. The computer-implemented method further comprises monitoring execution of a testing process of the MUT within the testing environment to detect occurrence of the testing process nearing completion. In response to detecting that the execution of the testing process is nearing completion, the computer-implemented method further comprises: (1) executing a first computer model on the MUT data structure to prioritize breaking of the MUT from the test environment; (2) executing a second computer model on operator data in an operator database to identify eligibility of one or more operators to be part of a break team to perform a break out operation on the MUT to break the MUT from the test environment; and (3) generating an output specifying the break team in association with the MUT and a priority for breaking the MUT from the test environment based on results of the execution of the first computer model and the second computer model.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIGS. 1A and 1B are photographs showing a testing cell, and zoomed in portion showing cabling, in a mainframe server computing system test environment in accordance with one illustrative embodiment;

FIG. 2 is an example block diagram of the primary operational components of an optimized break team compilation engine in accordance with one illustrative embodiment;

FIG. 3A is an example flow diagram showing an example overall flow for automatically monitoring testing environment status, prioritizing machines nearing a break status, and compiling and assigning a break team to machines based on priority, availability, and skill sets in accordance with one illustrative embodiment;

FIG. 3B is an example flowchart outlining three routines that are executed in accordance with one illustrative embodiment;

FIG. 3C is a flowchart outlining an example operation for prioritizing MUTs that are nearing an exit or break state in accordance with one illustrative embodiment;

FIG. 3D is a flowchart outlining an example operation for break team compilation and assignment in accordance with one illustrative embodiment;

FIG. 4A is an example of a human operator (technician) details data structure in accordance with one illustrative embodiment;

FIG. 4B is an example of a machine details data structure in accordance with one illustrative embodiment;

FIG. 4C is an example of a priority listing output for machines under test in accordance with one illustrative embodiment;

FIG. 4D is an example of an eligibility listing output for a plurality of operators and machines under test in accordance with one illustrative embodiment;

FIG. 5 is flowchart outlining an example operation of an optimized break team compilation engine in accordance with one illustrative embodiment; and

FIG. 6 is an example diagram of a distributed data processing system environment in which aspects of the illustrative embodiments may be implemented and at least some of the computer code involved in performing the inventive methods may be executed.

### DETAILED DESCRIPTION

As noted above, in manufacturing environments, especially those involving the manufacture of computing devices or systems, e.g., mainframe server computing systems, blade server computing systems, computer control systems of various types, e.g., vehicle control systems, or the like, these complex machines must undergo rigorous testing for performance and reliability. That is, in the manufacturing environment, machines undergo an assembly and a subsequent testing process, where this testing is accomplished by physically loading the physical machine into a testing environment, such as a test cell (of a plurality of test cells of a test floor) in the case of a mainframe server computing system or server rack having a plurality of server computing devices that operate in conjunction with one another, wiring testing equipment and testing computer devices to the machine under test (MUT), and then executing a plurality of tests on the hardware and/or software of the MUT. Sequences of test tools are applied to the MUT with each of the test sequences accomplishing specific goals. For example, a test tool operation may check if different parts of the processor related functions are tested. On the other hand, some test tools may target testing on attached IO, CPU, Power subsystems or Networking devices. A machine is deemed to be tested only after each predetermined step of testing is passed. Therefore, depending on the configuration of the MUT, the test can take many hours, days, or even weeks to complete. However, this testing is important to ensure that the MUT, e.g., a server or the like, meets quality and functional metrics, based on engineering specifications across all subsystems and at system level stack.

The testing is often accomplished by human subject matter experts (SMEs) that initiate tests, monitoring the testing to ensure that it is being performed correctly, making sure that the right tests are performed, and the like. While such SMEs make use of testing equipment and software to perform the tests, there is still a large amount of human intervention when performing the tests, which requires specialized skills and often a team of SMEs to perform the testing. That is, due to the finite number of available human operators (SMEs), and the skill sets needed by the human operators, test leads are usually tasked with managing the disposition of personnel to work on the various machines. These test leads are challenged to make consistent optimized decisions on the number of operators to deploy as well as maintaining the required skill sets to tend to the machines that require attention. In order to get the right human operators attending to the appropriate machines within a manufacturing test process, these test leads rely on their intuition, experience, and test status dashboards to make sound decisions of when and where to send their human operators.

However, reliance on human intuition and experience is a time consuming process and may lead to non-optimum decision making due to the limitations of human capabilities. Moreover, as a result, human test leads often rely exclusively on test status dashboard information alone which fails to take into consideration other factors. Test status does not always provide an accurate basis for predicting when a machine will be ready for exiting the testing environment. For example, the test status will not reflect the priority for exiting a machine from the test environment in terms of delivery day. As will be described herein, the illustrative embodiments look at other factors than merely what may be presented regarding test status, such as factors regarding the forming of the right break team, priority of breaking the MUT based on delivery schedule, and the like. The illustrative embodiments infuse additional parameters into the decision making algorithm to yield a priority for the MUT to exit the test environment/process which will optimize outcomes and minimize waste, such as in terms of time, revenue, and resources.

As can be appreciated, the testing of the machine may take a variable amount of time to complete based on a plethora of different factors, not the least of which is the need for human interaction and the variability of the availability of such human SMEs to engage in the testing process. This is especially true when such human SMEs are often performing testing a large number of different machines at substantially the same time. Moreover, variability in the performance of the tests may occur due to tests failing, needing to be rerun, different tests having to be performed for the particular machine, different configurations of machines needing different types of testing, e.g., one mainframe server computing system may be configured for one type of operation while another a different type of operation, and different tests may need to be performed based on their configurations.

Once a machine has been determined to have completed the testing in the testing environment, the machine must exit, or “break” from, the testing environment, with this exit process involving specific exit teams of human SMEs to physically remove the machine from the testing environment, e.g., test cell, and package the machine for shipping, travel, delivery and deployment at the customer location. This exit process must be done properly to ensure that the machine is not damaged in any way, and other neighboring systems under test are not disturbed and that all necessary components are packaged with the machine appropriately. As the testing environment involves multiple different physical connections, computing devices being coupled to the machine, etc., it is important that the human SMEs have the requisite knowledge to perform the operations of the exit process, which may include separating multiple components of the product that were connected together, to ensure proper exiting of the machine from the testing environment. However, the members of an exit team must handle multiple different testing environments and potential exits of different machines at substantially a same time. Thus, arranging for the availability of the exit team is a difficult task when dealing with large numbers of manufactured machines all being tested at substantially a same time and needing to exit the testing environments so that they may be packaged and shipped to customers.

Due to the variability in the testing process, there is no current methodology for accurately determining a time when the machine will be ready to exit the testing environment, e.g., “break” the machine from the testing environment. This is especially troublesome at periodic times, such as at the end of a month, end of a quarter, end of a fiscal year, etc., when production/manufacturing of the physical machines is increased due to increased demands. As a result, when a machine is ready to “break” from the testing environment, an exit team may not be available to perform the exit process for removing the machine from the testing environment and packaging up the machine for shipment to the customer. This will negatively impact production efficiency and introduce financial penalties associated with a longer time that the machine sits in the testing environment, e.g., test cell, unattended and not able to be exited from the testing environment. That is, in such a situation, not only is the machine not being made ready to send to the customer, but the testing environment is also occupied such that it cannot be used to perform testing of other machines. Manufacturing personnel cannot properly plan for future systems to enter the testing environment and testing cycle analysis may become skewed. In addition, environmental factors also play a part in additional costs of these inefficiencies in that energy usage and carbon footprint left by the test environment are increased as machines sit in testing environments being powered and waiting for exit teams to be able to removed them from the testing environment.

The illustrative embodiments provide an improved computing tool and improved computing tool operations that monitors the testing of machines under test (MUTs) and predicts, based on machine learning training of one or more machine learning trained computer models, e.g., neural networks, deep learning neural networks, recurrent neural networks, random forest computer models, and the like, a prioritization of machines that are nearing an exit state, i.e., a state at which point the machine may be exited, or “break” from a test environment, such as a test cell. The illustrative embodiments further automatically compile a break team, comprising one or more human operators, from available personnel, where this compilation is based on one or more machine learning trained computer models that compile the team based on availability of the human operators, skill sets of the human operators, and the needs of the particular machines, so as to determine a break team that will be able to perform the exit of the machine from the testing environment, i.e., the “break”, as efficiently as possible.

Thus, the illustrative embodiments provide an improved computing tool and improved computing tool operations that optimize allocation of human operators for exit teams dynamically and autonomously based on skills associated with the human operators. The allocation maximizes optimal outcomes as well as customer satisfaction by providing an improved automated tool that prioritizes machines based on a number of different factors, such as planned shipping date, particular customer to which the machine is being provided, frame count, and the like. With regard to frame count, what is meant is that for each order of a mainframe/server, the machine has a primary frame that contains processors and various additional subsystems depending on the configuration requested in the customer order. Additional frames/server computer may be needed to contain other subsystems and therefore, the number of frames in the MUT will vary depending on the requested configuration. Thus, the illustrative embodiments optimize human resource allocation dynamically based on skill sets and prioritization of machines ready to exit test environments, taking into account a variety of different factors, so as to provide an increase efficiency exit of machines from test environments.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular features or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

As described above, the illustrative embodiments of the present invention are specifically directed to an improved computing tool that automatically compiles a break team for breaking a machine out of a test environment. All of the functions of the illustrative embodiments as described herein are intended to be performed using automated processes without human intervention. While one or more human beings, may be the subject of the break team compilation, e.g., human operators and SMEs, the illustrative embodiments of the present invention are not directed to actions performed by these human operators or SMEs, but rather logic and functions performed specifically by the improved computing tool on test status data as obtained through automated monitoring of the testing environment and skill sets and availability of the various human operators or SMEs. Moreover, even though the present invention may provide an output to test lead's computing system that ultimately assists the test lead in assigning break teams to machine test environments, or automatically initiating performance of break operations by a break team, the illustrative embodiments of the present invention are not directed to actions performed by the team lead viewing the results of the processing performed by the illustrative embodiments, but rather to the specific operations performed by the specific improved computing tool of the present invention which facilitate improved break team allocation and increases efficiency with regard to machine testing and exiting of machines out of test environments. Thus, the illustrative embodiments are not organizing any human activity, but are in fact directed to the automated logic and functionality of an improved computing tool, and are not a mental process.

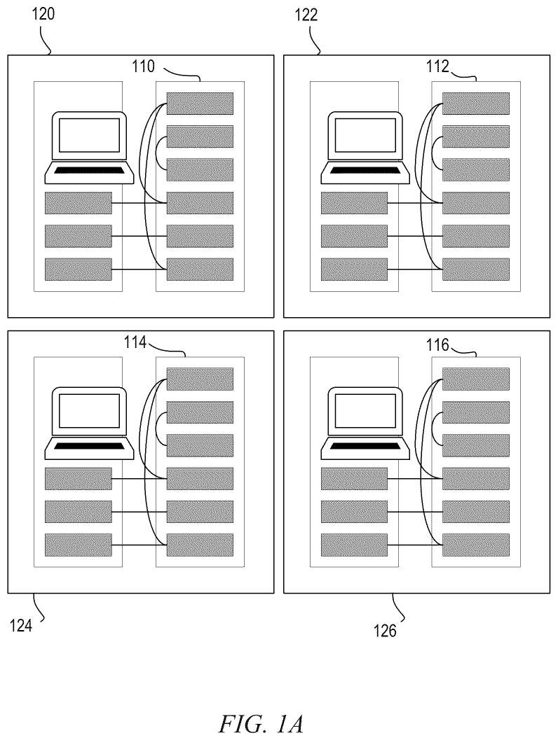

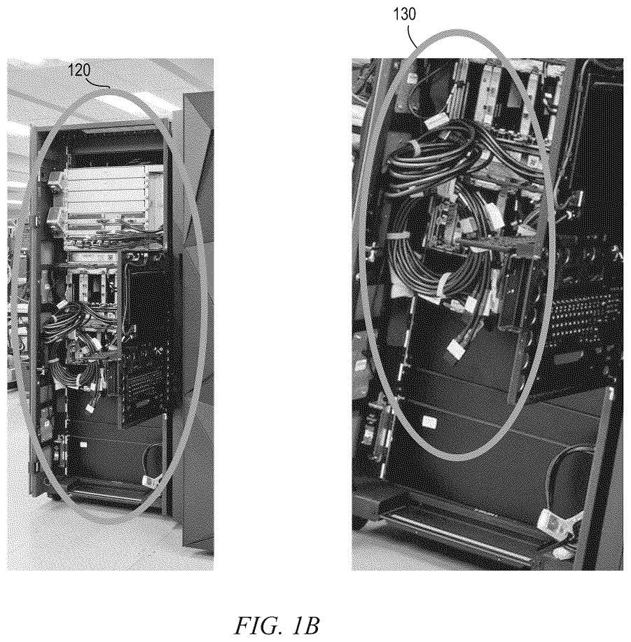

FIGS. 1A and 1B are photographs showing a testing cell, and zoomed in portion showing cabling, in a mainframe server computing system test environment in accordance with one illustrative embodiment. FIGS. 1A and 1B are photographs showing an example of a plurality of server racks or frames, referred to as a machine under test (MUT) 110-116, that have been placed into corresponding test cells 120-126. As shown in FIG. 1B, the test cells, taking test cell 120 as an example, comprises a plurality of physical wires and wiring harnesses 130, one or more testing computers 140, power couplings (not shown), data network couplings (not show), and other necessary physical and/or software elements that facilitate testing of the MUT 110. The coupling of the MUT 110 to the test cell 120 via the wires and wiring harnesses 130, is a complex operation that requires the human operator(s) to have a specialized knowledge of the MUT 110 and the particular tests being performed not he MUT 110 via the test cell 120. The human operators may need to configure the tests via the one or more testing computers 140 of each test cell 120.

To break a machine from the test cell 120, a break team comprising one or more human operators or SMEs is required to disassemble all the MUT 110 wiring and package the MUT 110 for shipping to the customer prior to exiting the machine from the test cell 120. Although breaking includes the unplugging of cables, cords and winding up the wires, there are specific procedures which need to be followed precisely and step by step by an operator who is trained for that process to maximize efficiency. This includes wrapping the wires and performing a final inspection on each frame to uncover, for example, damaged pins inside a connector. If the break team fails to detect such issues, this will require that the entire server goes back to the testing environment and this can further delay shipping of the machine to the customer. However, it is not known with accuracy when a particular MUT 110-116 will be ready to be broken out of the test environment. To the contrary, the test lead must manually inspect test results and determine when to break a MUT 110-116 out of the test environment. This is an error prone and inefficient process.

The illustrative embodiments provide an automated improved computing tool that has, as one end goal, the ability to automatically determine the right decision, rather than any decision, from a break priority perspective, as to when to break a MUT from the test environment and which operators should be included in the break team based on various factors. The illustrative embodiments, assuming a multitude of machines on the test floor and in respective test environments, and the various operators who are available on a given day and shift, as well as their skill level to fulfill a work order with efficiency because there are high level quality expectations associated with each server, makes such determinations and composes the break teams in accordance with MUT priorities so as to efficiently remove MUTs from test environments.

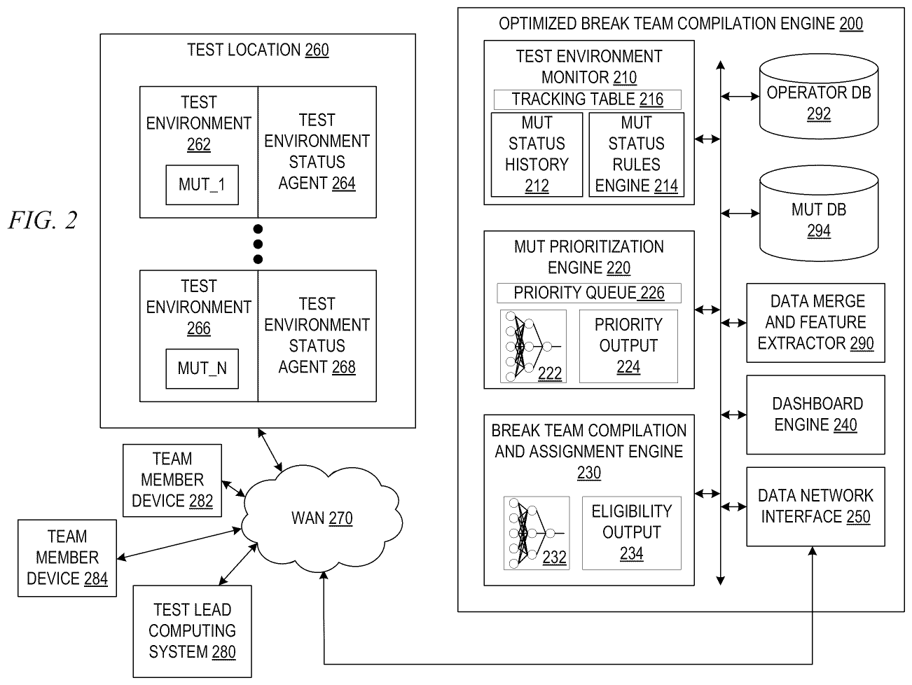

FIG. 2 is an example block diagram of the primary operational components of an optimized break team compilation engine in accordance with one illustrative embodiment. The elements shown in FIG. 2 are specifically implemented as computer hardware components and/or software components executing on hardware components, along with required data structures and storage systems, memory, and the like, for storing these data structures. While the primary operational components are shown in FIG. 2, it should be appreciated that other components that may be required to facilitate the operation of the depicted components may also be present but are not depicted in FIG. 2 so as to concentrate the present description on the inventive aspects of the illustrative embodiments. For example, these other components may include operating systems, libraries, databases, network adapters, application programming interfaces, and the like.

As shown in FIG. 2, the primary operational components of an optimized break team compilation engine 200, in accordance with one or more illustrative embodiments, includes a test environment monitor 210, a machine under test (MUT) prioritization engine 220, and a break team compilation and assignment engine 230. The optimized break team compilation engine 200 further includes an operator database 292, a machine under test database 294, a dashboard engine 240, and a data network interface 250. The optimized break team compilation engine 200 operates in conjunction with one or more test environments 262-266 of a test location 260 which may each have computing devices and corresponding test environment status reporting agents 264, 268. In addition, the optimized break team compilation engine 200 further may operate to interact with one or more test leads and one or more team members via the computing devices 280-284 and wide area data network 270, which may be a wired, wireless, or combination of wired and wireless data networks.

In operation, at the test location 260, machines under test (MUTs), e.g., MUT_1 to MUT N may be physically installed into corresponding test environments 262, 266 which have associated test environment status agents 264, 268. That is, the test environments 262, 266 may be test cells of a testing area at a manufacturing site or testing site, which may be the test location 260. The test environment 262, 268, as noted above, includes the physical wiring, test computing devices, power connections, data communication connections, and the like, for testing the operation, performance, and reliability of the MUT in accordance with a predefined testing process. This testing process may involve the application of automated tests on the MUT via the testing computers, may involve some interaction with human operators that oversee and ensure proper execution of the testing process, and the like. The test environment status agent 264, 268 monitors the performance of the testing process and reports the current status of the testing process to the test lead computing system 280 and optimized break team compilation engine 200, in accordance with one or more of the illustrative embodiments.

For example, as the MUT is tested by the test environment 262, 266, status updates are generated to indicate various states including initiation of a test, failure (or hold status) of a test, successful passing of the test, performance measures, reliability measures, and the like. These status updates are monitored by the test environment status agents 264, 268, which in some cases may be software logic executing on one or more of the testing computing devices of the corresponding test environment 262, 266. The test environment status agent 264, 268 transmits the monitored status information to the test lead computing system 280 and optimized break team compilation engine 200, potentially pre-processed and/or in response to particular events (e.g., a test operation completing successfully, a test operation entering a hold state, or the like) or periodic time intervals. For example, the test environment status agents 264, 268 may maintain a status history data structure and then in response to an event or elapse of time, the status history data structure may be communicated to the test lead computing system 280 and optimized break team compilation engine 200. At the test lead computing system 280, a test environment monitoring suite of tools may be executed to present information about the current status of the testing for each of the test environments 262, 268 and corresponding MUTs.

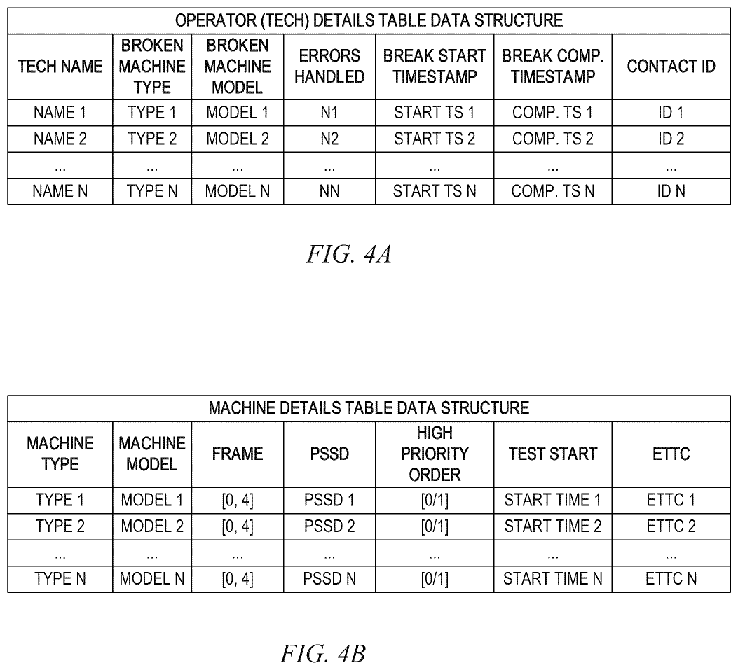

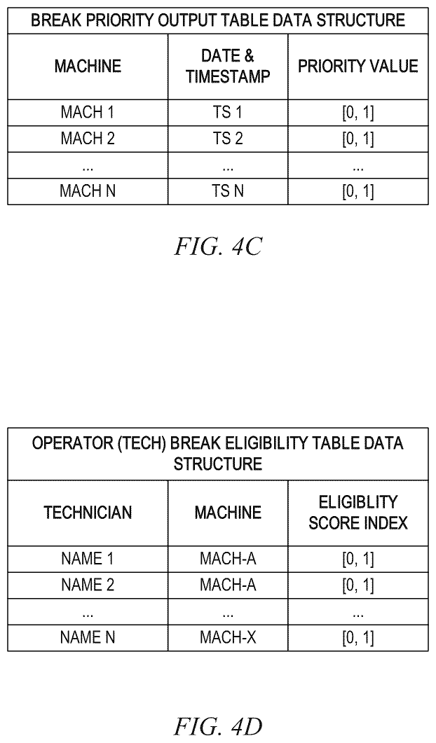

At the optimized break team compilation engine 200, the received status update information from the test environment status agents 264, 268 may be received via the data network interface 250 and used to update a MUT database 294. That is, when a MUT is installed into a test environment 262, 268, information about the MUT is transmitted to the optimized break team compilation engine 200, either directly from the test environment computing systems, the test lead computing system 280, or the like. This MUT information may include, for example, data such as that shown in FIG. 4 hereafter, e.g., machine type, machine model, number of frames, planned ship date/time, and the like. This information is used to generate an entry in the MUT database 294 which may later be updated with additional information, such as testing status, predictions of estimated time of completion of tests, priority classifications, and the like, based on the test environment status agent 264, 268 and/or the components of the optimized break team compilation engine 200. In some cases, the update information regarding the testing status, estimated time of completion, priority, etc., may be maintained in a tracking table 216 of the test environment monitor 210 and correlated with MUT data in the MUT database based on a MUT identifier or the like. In still other illustrative embodiments, the tracking table 216 and MUT database 294 may be merged into a single set of data structures for each MUT currently in a testing environment, e.g., each of MUT_1 to MUT n.

In addition to the MUT database 294, the optimized break team compilation engine 200 further includes an operator database 292 which includes an entry for each human operator that may be part of a break team. Each entry may include information about the machine types and models that this human operator has previously handled as part of a break team, the number of issues or errors handled by this human operator as part of a break team, a total number of frames the human operator has assisted with as part of a break team, and amount of time, or a statistical measure of the amount of time, that was required to perform the break operations for those in which the human operator was a member of the break team, contact information for the human operator, and the like. In general, any information that may be used to measure the human operator's past performance as part of a break team, the human operator's skill set with regard to different types and models of machines and ability to handle errors during the break operation, and the speed by which the human operator is able to perform the break operation may be part of the human operator's corresponding entry in the operator database 292.

The test environment monitor 210 comprises logic to monitor the test environments 262, 268 in which the MUTs are being tested, store MUT status history data in the MUT database 294, and apply rules to the MUT status to determine if a MUT is reaching a test state indicating that it is nearing test completion and needing to be exited from the test environment 262, 268. For example, the MUT status history engine 212, in response to receiving test environment status update information from agents 264, 268, analyzes the MUT status data and updates a MUT status in the corresponding entry of the MUT database 294 and/or the tracking table 216. The MUT status history engine 212 may provide the MUT status analysis results as well as information retrieved about the MUT from the MUT database 294 to the MUT status rules engine 214 for application of one or more predetermined rules to this status update analysis information and MUT information. Alternatively, the MUT status rules engine 214 may operate directly on the tracking table 216 to apply rules to the MUT status information reflected in the entries of the tracking table 216 and, for MUTs nearing completion or experiencing an issue, e.g., in a hold status, correlating the MUT identifiers with MUT data in the MUT database 294 when needed.

The MUT status rules engine 214 applies one or more predetermined rules corresponding to the type/model of the MUT, the test environment 262, 266, or the like. These rules may be different for different MUT types/models and test environment types so as to have different completion nearing criteria for different test processes, different types of machines, and the like. The rules comprise logic that may be applied to the MUT database 294 and/or analysis of the MUT status update information, such as may be present in the tracking table 216, to determine if the MUT testing process is nearing completion or if an issue has been detected to be present in the MUT testing process. While the illustrative embodiments are described in the context of predetermined rules, it should be appreciated that the rules may be computer executed logic or any other data structure or computer mechanism that evaluates criteria to determine if the state of the MUT testing is indicative of an issue that needs to be resolved or a state where the MUT will be exiting the test environment.

These rules are defined to specify criteria that, if satisfied, indicate issues with the testing being performed in the test environment 262, 266, and/or criteria indicating that the MUT is nearing completion of the testing process and will need to be exited from the test environment 262, 266. In the case that the MUT status rules engine 214 applies rules with a result indicating that an issue has been found in the testing of the MUT, e.g., a hold status, then a notification may be transmitted via an appropriate communication channel to the test lead computing system 280 and/or test team members indicating the existence of the issue and the operation may continue to monitor the status of the MUT, which may include determining that the issue has been resolved and performing further issue identification and/or key operation performance indicating that the MUT is nearing testing process completion and will need to be exited from the test environment.

For example, the overall test of a MUT consists of applying a sequence of different tests, each test having one or more test operations. A new test operation of a test is started only when the previous test operation passed successfully. On the other hand, a test operation may result in a hold condition if an issue or problem is encountered during the test operation and thus, this test operation does not pass. A tracking table data structure 216 may be generated in the test environment monitor 210 and/or in the MUT database 294 (not shown) that maintains, for each MUT presently in a testing environment, the key information for the MUT including the MUT identifier, current test operation, hold discovered flag, a timestamp of the hold flag status, and the estimated time to completion of testing process, for example. The information for a MUT in the tracking table data structure 216 may be updated when an event occurs during the testing of the MUT, where this event may be, for example, a new test operation being initiated in the test environment 262, 266, a test operation reaching a hold status due to a problem that was discovered during the test operation, or the like. Corresponding elements of the entry for the MUT in the tracking table data structure 216 will be updated, e.g., the current test operation may be updated, the estimated time to completion may be updated based on historical information about how long each test operation in a testing process takes to complete, the hold discovered flag may be set if the test operation is in a hold status, and the timestamp of the hold status may be updated accordingly. In addition, the entry in the tracking table data structure 216 may specify whether or not the MUT has been sent to the MUT prioritization engine 220, i.e., when the testing of the MUT is determined to be nearing completion or in a hold status.

It should be appreciated that, as the number of passing test operations increases, the possibility of a successful test, and therefore, the end of test, increases. A test operation can be marked as a key operation if the historic success of that test operation is high and all other test operations that come after it do not, usually, cause test failures, e.g., the subsequent test operations may be just writing statistics or the like. Which test operations are key operations and the conditions under which such operations are determined to be key operations, e.g., if the current test process is process A, the estimated time to completion is less than X, and if no hold status has been detected, etc., may be specified within the rules implemented by the MUT status rules engine 214. Thus, by querying the tracking table data structure 216, and applying the one or more rules of the MUT status rules engine 214, a determination may be made based on the current test operation as to whether that test operation corresponds to a key operation. If the current test operation is a key operation, then the MUT information in the tracking table data structure 216 may be sent to the MUT prioritization engine 220 for prioritization.

In the event that the MUT status rules engine 214 applies rules to the MUT status update analysis results and/or MUT information and determines that a key operation has been reached in the testing process, or if other conditions exist that are indicative of the MUT nearing a state of the testing process where the MUT will need to exit the testing environment, then the MUT prioritization engine 220 is invoked to determine a priority of the MUT for breaking the MUT from the test environment. The MUT prioritization engine 220 may maintain a priority queue data structure 226 in which entries for each of the MUTs nearing completion may be maintained, and may be sorted according to prioritization criteria. For example, the tracking table data structure 216 may be queried for entries that have not already been sent to the priority queue 226. These entries may be sorted according to those that have a hold status, which may be ordered from latest time stamp to earliest timestamp, and then by those that do not have a hold status which may be sorted according to longest to shortest time to completion, or break time, in an ascending order, for example. These entries may then be evaluated by the MUT status rules engine 214 to determine if a key operation has been reached and a threshold of the time to completion has been reached where the state indicates that the MUT will be soon ready to exit the testing environment. In this case, the machine information, similar to that discussed above with regard to the tracking table data structure 216, is used to populate an entry in the priority queue 226 along with a priority score that is calculated by the MUT prioritization engine 220 as discussed hereafter.

In some illustrative embodiments, the priority determination uses a set of one or more formulas to calculate the priority of each MUT for relative ranking of the MUTs in the priority queue data structure 226. These one or more formulas apply weights to factors that are important in terms of determining a priority of the MUT with regard to exiting or breaking from the test environment. For example, machine information from the tracking data structure 216 and/or MUT database 294, or calculated from the machine information retrieved from these sources, may include days to ship (DTS) (sooner shipment dates are prioritized), estimated time to completion (ETTC) (closer completion times are prioritized), machine complexity (CPLX) (more complex machines take longer to process out of the test environment and therefore are prioritized), and external influence (EI) which may be a value of 0 or 1 where management can override to force a high priority value, and other factors in the machine information may be utilized in these formula and weighted according to a desired weighting scheme to calculate priority scores. For example, in one illustrative embodiment, the priority score may be calculated as follows:

Priority Score=(W1/DTS)+(W2/ETTC)+(W3*CPLX)+(W4*EI)

where the weights are W1, W2, W3, and W4, for each of the factors discussed above, and may be the same value or different values. Thus, with the above formula, as the DTS increases, and thus there are more days until shipping, the priority is reduced. As the estimated time of completion increases, and there are more days that the MUT will be in testing, the priority is reduced. As the complexity increases, the priority increases as it will require more time and effort to exit the MUT from the test environment. Lastly, if an authorized user believes this MUT to be of high priority, then the priority increases. The weight values may be predetermined or may be learned over time based on a supervised machine learning where the priorities of MUTs are generated and user feedback is provided that indicates a correctness or incorrectness of the priority such that the weights may be adjusted based on the user feedback. Of course, this is just an example and other formula taking into account these and other factors of priority of MUT, as may be obtained from or derived from the information maintained in operator database 292, MUT database 294, the tracking table 216, may be used without departing from the spirit and scope of the present invention.

In some illustrative embodiments, this priority score determination may be based on a machine learning trained computer model 222 that is trained to generate a priority score or value calculation, or classification, based on input features, where this priority value calculation or classification may be a quantifiable value indicating a relative priority of the MUT for breaking the MUT out of a test environment relative to other MUTs in other test environments that are also nearing a state where these other MUTs are to exit their test environments. The input features upon which the ML trained computer model 222 operates may be extracted from a merging, or querying, of the operator data from operator database 292 and the MUT data from the MUT database 294 and tracking table data structure 216, which again may be updated based on testing process updates from the test environment status agents 264, 268. For example, the input data may be the various factors discussed above in some illustrative embodiments, e.g., DTS, ETTC, CPLX, and EI. The data merge and feature extractor 290 may operate on the data from the databases 292 and 294 and tracking table data structure 216 to merge (query) the data, e.g., merging by executing a SQL code or the like, which is then used to determine a priority of the MUTs for exiting the testing environments, as described hereafter.

In one illustrative embodiment the machine learning (ML) trained computer model 222 is a neural network computer model having a plurality of layers of nodes and weights applied to connections between nodes, where these weights are learned through a machine learning process and a corresponding loss function and machine learning training methodology, such as a stochastic gradient descent (SGD), linear regression operation, or the like. In accordance with the illustrative embodiments the ML trained computer model 222, which may also be referred to as a MUT prioritization computer model 222, receives input features representing the MUT's testing status, the MUT itself, and/or other features or factors indicating availability of human operators, planned ship date, and the like, as extracted from the merged data from database 292, 294 by data merge and feature extractor 290. In one example, the input features may include planned ship date or DTS, such as in terms of days of the year [1, 365], a high priority order [0/1], an estimate as to an amount of time that is still left for completing the testing process or ETTC, such as in terms of hours [1, 24] or the like, a complexity or CPLX, a number of available operators to be part of the break team [1, n] or availability, as discussed hereafter, and an influencing point feature, or EI, having values [0, 1].

In some illustrative embodiments, the nodes of the ML trained computer model 222 may operate based on an activation function that is defined according to the desired implementation. The weights of the activation functions for the various nodes are learned through the machine learning process by using a training dataset and ground truth data along with a loss function that determines the difference between the generated priority value classification and the ground truth priority value classification for the training data. That is, a portion of training data is input to the model 222 which generates a priority value output based on the recognized patterns of features in the input, and this priority value output is compared to the ground truth to determine a loss based on a loss function. The loss is then evaluated by the machine learning algorithm to identify a modification to the operational parameters of the model 222, e.g., a modification to the weights of particular nodes, e.g., nodes that had the most influence on the priority value output, and the process is repeated with the same or different training data. This process repeats until a convergence criterion is satisfied, e.g., the loss is equal to or below a given threshold loss, or a predetermined number of iterations (epochs) have been executed. After convergence, the model 222 is considered to have been trained and the trained model 222 is then applied to new data during a runtime operation and generates priority output values 224 for prioritizing the MUT exit operation relative to other MUTs nearing test completion and an exit stage for exiting the testing environment.

Thus, in some illustrative embodiments, a prioritization of MUTs that are nearing a break time is generated either by application of a set of one or more formulas applying weights to various factors extracted or derived from the MUT database 294, the operator database 292, and the tracking data structure 216, where the weights themselves may be defined by subject matter experts or may be learned over time. In other illustrative embodiments, the prioritization of the MUTs may be based again on these various factors and features extracted or derived from the MUT database 294, the operator database 292, and the tracking data structure 216, but where machine learning computer models are trained to generate a priority score (value) or classification based on an input of these factors/features.

Similar to the MUT prioritization engine 220, the break team compilation and assignment engine 230 may operate based on a set of one or more formulas, or may operate using a machine learning trained computer model 232 that may be trained using training datasets, ground truth data, loss function evaluation, and machine learning algorithms to modify the operational parameters of the model 232. The set of formulas or machine learning trained computer model 232 operates to determine an eligibility of each operator in the operator database 292, or a subset of such operators, to be assigned to a break team for a given MUT, determines a number of operators needed for breaking the MUT from the test environment, and selects such operators for inclusion in the break team.

For example, in an embodiment that utilizes a set of one or more formulas, the break team compilation and assignment engine 230 comprises logic that queries all rows of the priority queue 226 that have not already been sent to the break team compilation and assignment engine 230, sorted by priority score, such as in a descending order. The logic of the engine 230 then determines for each MUT whose entry was retrieved from the priority queue 226, i.e., those that are nearing completion and which have had their priority scores determined by the MUT prioritization engine 220, an eligibility of each operator in the operator database 292, or a subset of such operators. This determination of eligibility may involve using a set of one or more formulas to calculate an eligibility score for each of these operators taking several factors into consideration, where these factors may be obtained or derived from the information maintained in the operator database 292. These factors may have different values depending on the particular characteristic of the particular MUT for which the operator is being considered for the MUT's break team.

As an example, given a particular MUT's characteristics, e.g., type, model, etc., the various operator factors that may be evaluated in generating an eligibility score may include an operator, or technician, experience (TE) factor which may be derived from information as to how many machine types of the same type as the MUT the operator/technician has serviced in the past, where the types may be based on specific types or a machine family, e.g., different individual types, but all related to the same general group of similar type machines, referred to as a machine family. The operator factors may further include how many errors have been solutioned (ES) by this operator/technician. The operator factors may include an average break time (ABT) for systems of a similar complexity as the current MUT. Other types of operator factors that may be considered include the total defect count (DC) of the MUTs that the operator/technician has worked on (where ES/DC is solved problems over all problems), training course completed by the operator/technician out of an entire education series, i.e., a training percentage (TRP), technician speed index (TSI), which is a quantity calculated as an subject matter expert (SME) define time divided by ABT, a number of machines serviced by the operator/technician (MBT), a number of machines (referred to as ABTY) assigned to the particular operator/technician that have a same priority score within a given tolerance, e.g., +/−10, and the like.

The operator/technician's availability may also be taken into account, where this availability may be derived from a work schedule and a number of systems of similar priority, i.e., within a given range of the priority score of the current MUT, i.e., ABTY, that the operator/technician has in their queue, where such information may be present in the operator database 292. In addition, the set of formula may evaluate other technicians' availability and experience to evaluate whether to assign the current operator/technician or one of the other technicians that may have more availability or more experience, for example. Thus, if there is a highly qualified technician with low availability, they will score lower than someone with lower experience but with more availability for the MUT that needs to have a break team assembled.

An example formula that may be included in the set of one or more formula for determining the operator/technician's eligibility may be of the type:

Technician Eligibility Score(TES)=TE+TSI+ABTY (1)

where again, TE is a technician experience, which may be calculated, for example, as TE=(ES/DC)*MBT*TRP, for example, TSI is a ratio of an SME defined time to the actual break time of the MUT, and ABTY is the number of machines assigned to the operator/technician having a same priority within a given tolerance. Thus, inserting these into equation (1) above, one obtains:

TES=(ES/DC*MBT*TRP)+(SME defined time/ABT)+ABTY (2)

While no weights are included in this example, it should be appreciated that in some implementations, weights may be determined and applied to the various factors to weight more/less the factors that are deemed to be more important to determine an eligibility score for operators/technicians. Thus, for example, if TE is considered more important, then it will be more heavily weighted compared to the other factors. Of course, this is just an example and other formula taking into account these and other factors of eligibility of an operator/technician as may be obtained from or derived from the information maintained in the operator database 292 may be used without departing from the spirit and scope of the present invention.

Based on the eligibility scores for the various operators/technicians, and priority factors evaluated to generate the priority scores for the MUTs, a number of operators/technicians needed to be part of the break team for the MUT is determined. This determination may be based on one or more formula that take into consideration the complexity of the MUT and availability of the operators/technicians, for example. In one illustrative embodiment, each break team is defined as requiring one operator that has an experience level, e.g., TE, above a given value, and other operators/technicians below that experience level that have an availability that covers the entirety of an estimated time for breaking the MUT from the test environment. In some cases, this number of operators may be fixed, e.g., 1 experienced operator and 3 less experienced operators. In other embodiments, the number of operators may be variable with a minimum number of different experience levels, but with the actual number assigned to the break team being dependent upon availability and relative experience levels, e.g., one needs less number of operators if these operators are more experience, but may need more operators if more experience operators are not available. Based on these formulas, or rules, operators/technicians are selected based on the eligibility scores in accordance with break team formation criteria.

In an embodiment in which a machine learning trained computer model is utilized, the model 232 may be a neural network, deep learning neural network random forest, or other machine learning computer model which is trained through a machine learning process and in which nodes of the model 232 may utilize a similar activation function whose operational parameters are learned through the machine learning operation. However, in this case the machine learning trains the model 232 to predict an eligibility score for each operator in the operator database 292, or subset of such operators, relative to the requirements for performing an exit operation on a given MUT and testing environment 262, 266. That is, the merged data and features extracted from the merge data may be input to the break team compilation and assignment engine 230 which then, for each MUT nearing a completion of the testing process as indicated in the priority output 224 of the MUT prioritization engine 220, for each operator in the operator database 292, the model 232 calculates an eligibility score indicating a level of eligibility for the operator to be part of the break team for breaking the MUT from the test environment 262, 266. In the case of the computer model 232, which may be referred to as a break team membership eligibility computer model 232, may receive input features, such as the eligibility factors discussed above and/or other factors, e.g., as a total number of frames broken by the particular operator, a total number of errors handled by the particular operator, a number of machines of the same type as the MUT that have been broken by the particular operator, a number of machines of the same model as the MUT that have been broken by this operator, and a machine frame count. This pattern of input features may be correlated with eligibility scores so as to calculate an eligibility score for an operator.

Thus, given a set of input features, the model 232 predicts an eligibility score, such as within a range [0, 1] for each operator and the top K operators for inclusion in the break team may be selected for assignment to the break team. In performing the assignment, the break team compilation and assignment engine 230 may have logic for selecting one or more team members that have specific skills for performing a break operation for the particular type/model of the MUT, while other team members may be selected to support the specialized team members and which do not have the specific skills for the particular type/model of the MUT. For example, as noted above, there may be various rules or formula for evaluating the experience level and availability of operators/technicians and which set forth requirements of break team composition, e.g., 1 experienced operator/technician and a minimum of 3 other operator/technicians.

It should be appreciated that this eligibility scoring may be performed with regard to each operator in the database 292, or may be performed with regard to a subset of operators selected from the operator database 292. For example, a subset of operators may be selected from the operator database 292 based on which operators have historical data indicating that they have operated as part of a break team during a break operation for MUTs having similar types/models previously. In such a case, the operations may be performed on this subset and the operators having the highest eligibility scores may be selected as primary members or break team leads while others may be selected for supportive roles to support the primary members with actions that do not necessarily need specialized skills or experience. Thus, the eligibility output 234 may be used by the break team compilation and assignment engine 230 to select a number of operators to be part of a break team for a particular MUT in the priority output 224, such as by evaluating availability and expertise of the operators/technicians in the manner previously described above.

The priority output 224, eligibility output 234, and break team selection and assignment may be output to the dashboard engine 240 for generating a break team dashboard output that may be output to the test lead computing system 280 via the data network interface 250 and the one or more data networks 270. The dashboard generated by the dashboard engine 240 may be an interactive user interface through which a test lead viewing the dashboard on the test lead computing system 280 may see a priority listing of MUTs based on the priority output 224, which operators are eligible for inclusion in the break team for each MUT in the priority listing, and which operators were selected for inclusion in the break team for that MUT. User interface controls may be available in the dashboard for the test lead to modify the priority listing, i.e., rearrange the MUTs according to the user's determination of a priority modification, or modify the assignment of operators to the break team, such as in the case where the test lead believes that more efficient break operations may be achieved by changing the break team assignments. Modifications may be reported back to the break team compilation and assignment engine 230 and used to update the training of the model 232 by modifying operational parameters or weights that influence priority determinations, modifying operational parameters or weights that reduce the eligibility scores for operators removed from the break team and increase the eligibility scores for operators added to the break team, or the like. In addition, user interface elements may be provided for confirming the break team membership, which may then be reported back to the optimized break team compilation engine 200 which may update the operator database 292 based on the confirmation.

The test lead may then, via the dashboard, initiate an automated communication with the team members via the network(s) 270 and the team member communication devices 282, 284 to inform them of their assignment to the break team for particular MUTs and initiate their operations for breaking the MUT out of the test environment 262, 266. In some alternative illustrative embodiments, the dashboard engine 240 may, in addition to, or instead of generating the dashboard, send communications to the break team members devices 282, 284 to inform them of their assignment and initiate their operations for breaking the MUT out of the test environment 262, 266.

It should be appreciated that the generation of the break team via the mechanisms of the illustrative embodiments is performed prior to the MUT reaching a state for exiting the test environment and is determined through automated mechanisms using machine learning computer models. Thus, a break team is automatically generated that maximizes the efficiency of the break out operation and minimizes the time that the MUT remains in the test environment after testing is completed or a state is reached where the MUT may be exited from the test environment. That is, the break team is compiled proactively prior to when the break team will be needed to break the MUT out of the test environment such that the time the MUT is located in the test environment after completion of the test process is minimized and the MUT can be more quickly and efficiently exited and packaged for shipping and delivery to the customers.

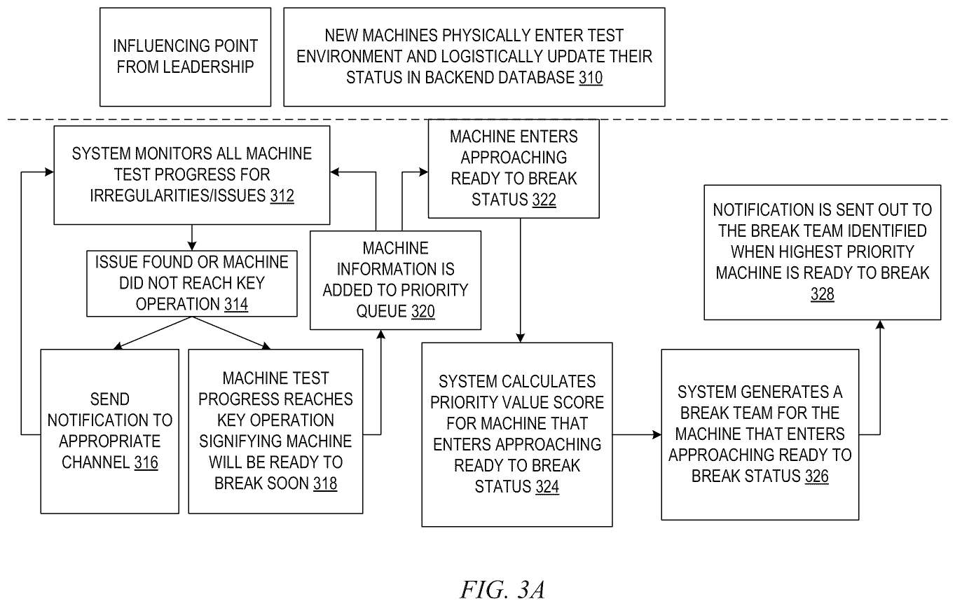

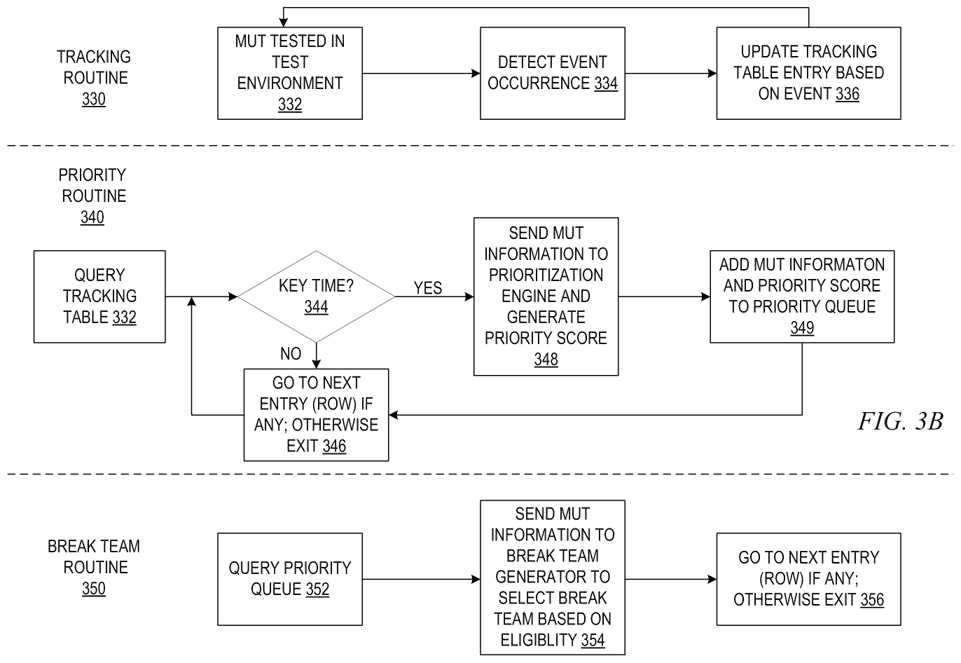

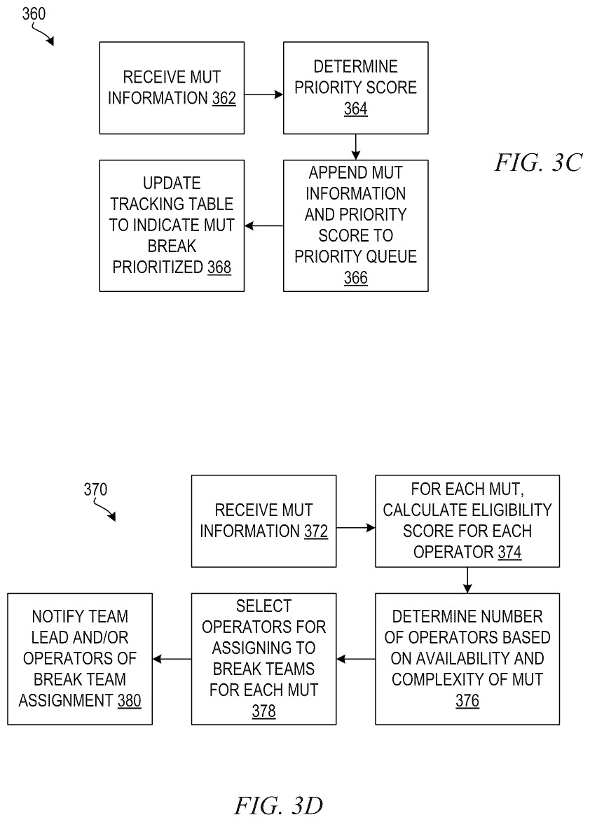

FIG. 3A is an example flow diagram showing an example overall flow for automatically monitoring testing environment status, prioritizing machines nearing a break status, and compiling and assigning a break team to machines based on priority, availability, and skill sets in accordance with one illustrative embodiment. The flow in FIG. 3A may be implemented using the components of the optimized break team compilation engine 200 in FIG. 2, for example. The flow assumes that some data structures and configurations of the components are already performed and that the models 222 and 232 have been trained. For example, the operator database 292 is already populated with operator information and may be updated with availability information for the operators dynamically via the test leader computing system 280 which may identify when operators are “on the job” and when operators are already assigned to MUTs and test environments.

As shown in FIG. 3A, the flow first involves new machines, i.e., MUTs, being physically installed in the test environment and logistical updates of the MUT status being performed with the backend databases, e.g., MUT database 294 (step 310). The system, e.g., computer system implementing the engine 200, monitors all the machine test progresses for irregularities/issues/key operation performance (step 312). That is, the agents 264, 268 monitor the test process being performed at each test environment 262, 266 for events indicating irregularities, issues, or key operations being performed that are indicative of the MUT's test process nearing a completion where the MUT needs to exit the text environment. A determination is made as to whether an issue is found or the MUT testing process has reached a key operation (step 314). If such an issue is detected, an appropriate notification is generated and sent (step 316) indicating the issue so that it may be resolved. If a key operation performance is detected that signifies the MUT is nearing test completion and will need to break from the test environment soon (step 318), then the machine information is added to the priority queue (step 320).

As the machine approaches the “break” status (step 322), the system calculates a priority value score for the MUTs that are entering the approaching ready to break status (step 324). The priority value scoring may be performed by the MUT prioritization engine 220, for example, based on features or factors extracted from the merged operator and MUT data from the database 292, 294, as merged and extracted by the data merge and feature extractor 290, and using either a set of one or more formulas or a machine learning trained computer model to generate such priority scores or values. The system also generates a break team for the MUT that enters the approach ready to break status (step 326). The break team may be generated by the break team compilation and assignment engine 230, for example, again using either a set of one or more formulas or a machine learning trained computer model. Notification is sent out to the test leader and break team, such as when the highest priority MUT is ready to break or exit from the test environment, or other suitable time (step 328). In some cases, this notification may be an interactive dashboard output, and may be provided in a continuous manner and/or updated periodically as there are changes to the priority queue, as MUTs enter a ready to break state, or the like. In addition, such notifications may include notifications to operators/technicians that are selected for inclusion in a break team of a MUT that is ready to break from the test environment. The operation then terminates.

FIG. 3B is an example flowchart outlining three routines that are executed in accordance with one illustrative embodiment. As shown in FIG. 3B, a tracking routine 330 operates to monitor the testing performed on the MUT in the test environment and update a tracking table 216 based on this monitoring. A priority routine 340 operates to update a priority queue 226 based on the tracking table 216 and a determination of a MUT entering a nearing exit or nearing break state. A break team routine 350 operates to generate a break team for a MUT that is entering a nearing exit or nearing break state based on the priority queue 226.

In the tracking routine 330, which may be implemented, for example, in the test environment monitor 210, in a first operation, the MUT is tested via the testing environment and testing equipment (step 332). As the testing is being performed, when an event occurs (step 334), such as progressing to a new operation within the test process or a test reaching a hold due to a problem that was discovered, an update of the tracking table is triggered (step 336). Again, the tracking table stores key information about the MUT, including MUT identifier (ID), current test operation, hold discovered flag, a timestamp of the hold discovered flag being set, an estimated time to completion of the testing, and a flag indicating whether or not the MUT information has been sent to the MUT prioritization engine 220, i.e. the priority queue 226, for prioritization of break out operations.

In the priority routine 340, which may be implemented, for example, in the MUT prioritization engine 220, periodically or in response to a change in the state of the tracking table data structure 216 (such as is triggered by step 336), the priority routine 340 queries the tracking table data structure 216 to fetch rows that were not already sent to the priority queue 226, where these rows are sorted by holds first with the latest timestamp to the earliest timestamp, and then sorted by expected break time in an ascending order (step 342). For each fetched row, a determination is made as to whether a key time has been reached for that MUT (step 344). Again, a key time is a threshold where the MUT is determined to be nearing ready to exit its testing environment. If the MUT is not nearing ready to exit the testing environment, the operation goes to the next retrieved row, if there are any additional rows to process, and repeats the determination in step 344 (step 346). If the MUT is nearing ready to exit the test environment, then the MUT information is sent to the MUT prioritization engine 220 for determination of a priority score or value for the MUT (step 348). Based on the priority score for the MUT, the MUT information and the priority score are used to generate an entry in the priority queue data structure 226 which may be prioritized based on the relative value of the priority score to other entries in the priority queue data structure 226 (step 349). The operation then returns to step 344 until there are no more retrieved rows from the tracking table data structure 216.

In the break team routine 350, which may be implemented, for example, in the break team compilation and assignment engine 230, periodically, or in response to a change in the priority queue data structure 226, the priority queue is queried to fetch all rows that were not already sent to the break team compilation and assignment engine 230, where these rows may be sorted according to priority score in a descending order (step 352). The MUT information for a next selected row is sent to the break team compilation and assignment engine to determine eligibility of operators/technicians for inclusion in a break team for the corresponding MUT and operators/technicians are selected and notified of their assignment to break teams for MUTs (step 354). Once the row has been processed and a break team assigned, the operation goes to the next row, if there are any, and repeats the process (step 356).

FIG. 3C is a flowchart outlining an example operation for prioritizing MUTs that are nearing an exit or break state in accordance with one illustrative embodiment. As shown in FIG. 3C, the operation 360 starts by receiving MUT information from the tracking table data structure 216 and/or MUT database 294 for a MUT that is determined to be nearing an exit or break state, i.e., a MUT whose information has been sent to the MUT prioritization engine 220 by the test environment monitor 210 based on a status in the tracking table 216 indicating nearing exit or break state, such as by applying MUT status rules by engine 214 or the like (step 362). A priority score or value for the MUT is determined, e.g., through a set of one or more formula, through application of a machine learning computer model, or the like (step 364). The MUT information and the priority score/value are appended to the priority queue data structure 226 (step 366), and the tracking table data structure 216 is updated to set the value indicating that the MUT has been sent to the prioritization engine 220 for prioritizing break out of the MUT from the test environment (step 368). The operation then terminates, but can be repeated for each MUT that is nearing an exit or break state.

FIG. 3D is a flowchart outlining an example operation for break team compilation and assignment in accordance with one illustrative embodiment. As shown in FIG. 3D, the operation 370 starts by receiving MUT information for MUTs according to the prioritization in the priority queue 226, where this MUT information may be obtained from the entry in the priority queue as well as information present in the MUT database 294, for example (step 372). For each MUT, an eligibility score is determined for each operator/technician, or a subset of operators/technicians (step 374). Again, this may be done using a set of one or more formula and information retrieved from and/or derived from operator/technician information stored in the operator database 292, or may be generated by a machine learning trained computer model on operating on such operator/technician information as input features, for example.

Based on various factors, including machine complexity and availability of the operators/technicians, a number of operators/technicians is determined for the break team for each MUT (step 376). Based on the number of operators/technicians needed for the break teams, eligible operators/technicians are selected for each break team for each MUT according to priority and eligibility scores of the various operators/technicians for those MUTs (step 378). The selected operators/technicians are then notified of their assignment to particular break teams (step 380) an the operation terminates.

As noted above, the logic implementing sets of one or more formula and/or the embodiments in which machine learning trained computer models 222 and 232 are utilized, may operate on merged data and features extracted from this merged data. The merged data merges the operator (or technician) detailed data from the operator database 292 and the machine detailed data from the MUT database 294 and extracts features from this merged data.

FIG. 4A is an example of a human operator (technician) details data structure in accordance with one illustrative embodiment. As shown in FIG. 4A, the operator data may include an operator name or other identifier, broken machine type, broken machine model, number of errors handled, the break operation start and complete timestamps, and a contact identifier, e.g., email address, username, etc. for contacting the operator (technician). This information may be gathered for each break operation that the operator was a member of the break team. This information may then be used to update other measures of performance for the operator, such as measures that are aggregated across multiple different break operations for machines of similar type and model. For example, a count may be maintained for each operator of a number of each machine type and machine model that the operator was involved in a break team and break operation. Similarly, statistics such as the average time duration for performing the break operation, and a count of a number of errors handled by the operation across all break operations for that machine type and/or machine model. These features may be used as input to the machine learning model to determine which operators to associated with MUTs of similar type and model that are nearing a break stage or exit of the test environment.

FIG. 4B is an example of a machine details data structure in accordance with one illustrative embodiment. As shown in FIG. 4B, the machine detail data may include the machine type, machine model, number of frames, planned ship date (PSD), or planned server ship date (PSSD) in cases where the MUT is a server, high priority order indicating whether the order for the machine is considered high priority or not, test start time, and estimated time to completion (ETTC). This data may for the MUT may be used for prioritization and break team compilation and assignment in the manner previously described above with regard to one or more of the illustrative embodiments.

FIG. 4C is an example diagram of a break priority output, such as priority output 224 in FIG. 2, in accordance with one illustrative embodiment. As shown in FIG. 4C, the output may comprise a prioritized listing of MUTs, Mach 1 to Mach n, along with date and timestamp of when those MUTs were added to the priority output, i.e., when the MUTs were added due to the MUTs entering a nearing completion or near break out stage of testing. Each MUT entry in the priority output has an associated priority value in the range of [0, 1], which may be generated by the machine learning trained computer model 222, for example.

FIG. 4D is an example diagram of an operator (technician) break eligibility output, such as eligibility output 234 in FIG. 2, in accordance with one illustrative embodiment. As shown in FIG. 4D, the eligibility output may list the names of the operators that are selected for inclusion in a break team for each MUT, e.g., Mach-A, Mach-B, along with an eligibility score, such as may be generated by the machine learning trained computer model 232, for example.

With a combination of the outputs of FIGS. 4C and 4D, the system can prioritize MUTs for breaking out of test environments as well as identify break team members to handle the break out operation for breaking the MUT from the test environment. Based on this correlation, the specific break team members may be notified of the need to perform break out operations on a specific MUT. The break team members and prioritization of MUTs is performed using automated tools and machine learning training of the computer models to determine the optimum order of when MUTs should be scheduled for break out from the test environment and the optimum combination of break team members to handle the break operation based on their previous experience, availability, and the particular combination of specialty skills and supporting skills needed to perform the break out operation on the MUT and testing environment.

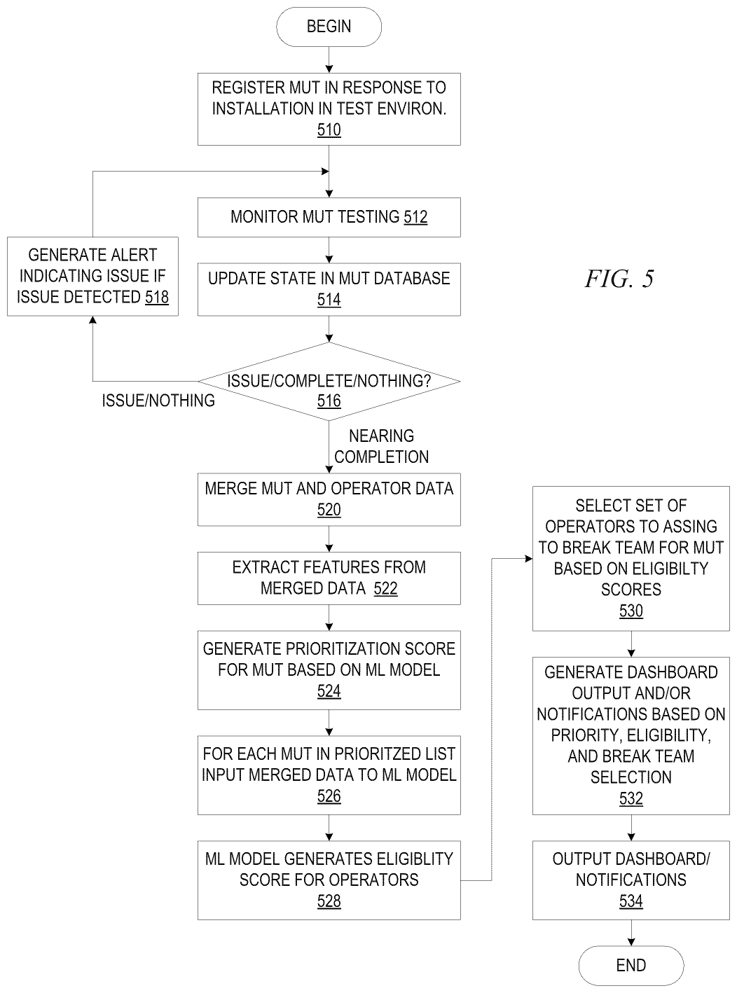

FIG. 5 is flowchart outlining an example operation of an optimized break team compilation engine in accordance with one illustrative embodiment. The operation outlined in FIG. 5 may be implemented, for example, by the optimized break team compilation engine 200 in FIG. 2, which is itself an automated improved computing tool performing improved computing tool operations in accordance with one or more illustrative embodiments as described above. It should be appreciated that the operations outlined in FIG. 5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 5, and may, in some cases, make use of the results generated as a consequence of the operations set forth in FIG. 5, the operations in FIG. 5 themselves are specifically performed by the improved computing tool in an automated manner.

As shown in FIG. 5, the operation starts by registering the MUT that in response to the MUT being installed into the test environment by storing MUT and/or test environment details in a MUT database along with updated testing environment information, e.g., timestamps, state, and the like (step 510). The testing process for the MUT is monitored by a testing environment based agent which reports current status information (step 512) and the MUT database is updated accordingly (step 514). The updated state is evaluated to determine if the state indicates an issue with the testing process, a state indicative of the MUT nearing test completion, or no issue/nearing completion (step 516). If the state indicates an issue, an issue alert or notification is transmitted to the test lead computing device (step 518) and the operation returns to step 512 where the testing process is continued to be monitored. If there is no issue or state nearing completion of testing, then the operation just returns to step 512 (without sending an alert) and continues to monitor the testing process. If the state indicates that the MUT is nearing a test completion state, then the MUT detail data is merged with the operator data from the operator database (step 520) and features are extracted from the merged data for input to a MUT prioritization engine (step 522). The MUT prioritization engine, based on its machine learning training, generates a prioritization score for the MUT to prioritize the MUT relative to other MUTs that are also in line for performance of break out operations and exiting their testing environments (step 524).

For each MUT in the prioritized list of MUTs ready for break out operations, features extracted from the merged data are input to a machine learning trained computer model of the break out team compilation and selection engine (step 526). The model generates an eligibility score for each operator, or a subset of operators (step 528) and the eligibility scores are used to select a set of operators to assign to the break team for the MUT (step 530). The break team identification, prioritization of MUTs, and eligibility determinations are used as a basis for generating a dashboard and/or notification outputs (step 532) which are then output to appropriate test leader computing systems and break team member communication devices (step 534). The operation then terminates.

Thus, the illustrative embodiments provide an improved computing tool and improved computing tool operation for automatically and dynamically generating a break team for performing break out operations for exiting machines from testing environments based on a machine learning learned association of input features of the MUTs and operators and optimum break team membership. The illustrative embodiments operate prior to the MUT reaching the point where it needs to exit the testing environment and selects an optimum combination of break team members that are able to perform the break out operation timely and efficiently. Thus, the illustrative embodiments minimize the time machines spend in testing environments waiting for a break team to perform the break out operation.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an automated mechanism for monitoring testing status of machines in test environments, prioritizing the machines for exiting the testing environments, and automatically assigning an optimized break team for breaking machines from testing environments that minimizes the amount of time that the machines stay in the testing environment after reaching a break status, i.e., after the machines are available to exit the testing environment. The improved computing tool implements mechanism and functionality, such as the optimized break team compilation engine 200, which cannot be practically performed by human beings either outside of, or with the assistance of, a technical environment, such as a mental process or the like. The improved computing tool provides a practical application of the methodology at least in that the improved computing tool is able to prioritize machines for existing the testing environment based on a plurality of different factors and assign an optimized break team for performing the exit of machines from the testing environment based on a plurality of factors of the human operators.

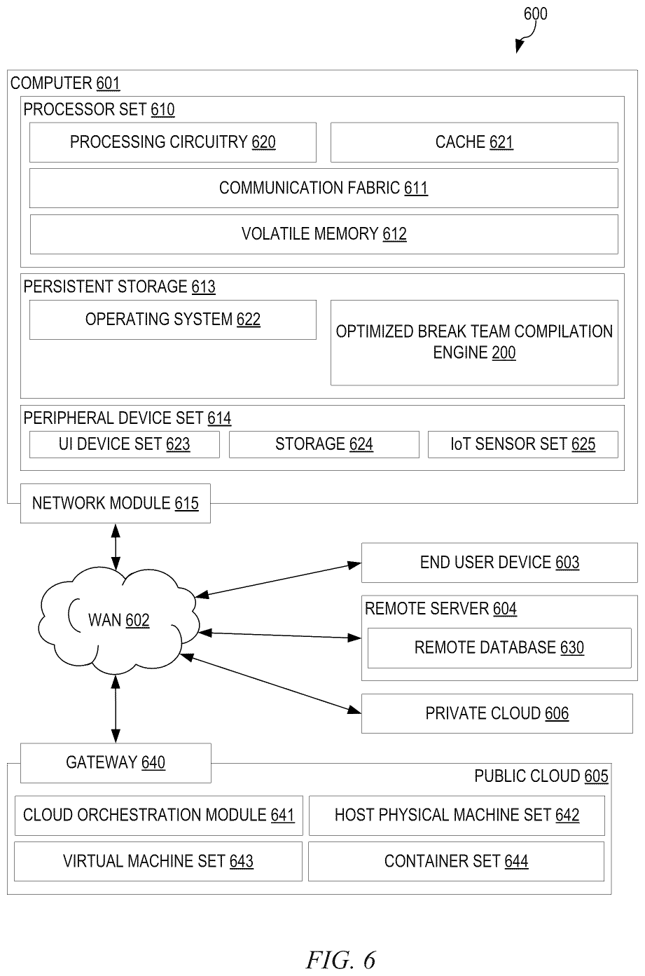

FIG. 6 is an example diagram of a distributed data processing system environment in which aspects of the illustrative embodiments may be implemented and at least some of the computer code involved in performing the inventive methods may be executed. That is, computing environment 600 contains an example of an environment for the execution of at least some of the computer code involved in performing the inventive methods, such as the optimized break team compilation engine 200 in FIG. 2. In addition to block 200, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 200, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 200 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 200 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As shown in FIG. 6, one or more of the computing devices, e.g., computer 601 or remote server 604, may be specifically configured to implement an optimized break team compilation engine 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 601 or remote server 604, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automated prioritization of MUT break out operations and exiting of MUTs from test environments, as well as optimum assignment of break teams to the MUT break out operations.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, executed in a data processing system, for assigning at least one operator to a break team to break a machine from a test environment, the computer-implemented method comprising:
generating, in response to installing a machine under test (MUT) in a test environment, a MUT data structure in a MUT database that stores machine detail data corresponding to the MUT;
monitoring execution of a testing process of the MUT within the testing environment to detect occurrence of the testing process nearing completion; and
in response to detecting that the execution of the testing process is nearing completion:
executing a first computer model on the MUT data structure to prioritize breaking of the MUT from the test environment;
executing a second computer model on operator data in an operator database to identify eligibility of one or more operators to be part of a break team to perform a break out operation on the MUT to break the MUT from the test environment; and
generating an output specifying the break team in association with the MUT and a priority for breaking the MUT from the test environment based on results of the execution of the first computer model and the second computer model.

2. The computer-implemented method of claim 1, wherein executing the second computer model on the operator data in the operator database comprises:
determining, for each operator in a plurality of operators registered in the operator database, a measure of correlation between first skills associated with the operators in the plurality of operators, and second skills required to exit the MUT from the testing environment; and
selecting the one or more operators based on the determined measure of correlation of each of the operators in the plurality of operators.

3. The computer-implemented method of claim 1, wherein the MUT data structure stores MUT characteristic data specifying a machine type, a machine model, a number of frames, and a planned ship date/time, and wherein the first computer model generates a priority measure for the MUT based on the MUT characteristic data.

4. The computer-implemented method of claim 1, wherein monitoring execution of a testing process of the MUT within the testing environment is performed by a test environment status agent executing in the test environment, and wherein the MUT data structure is updated with a status of the testing process based on the monitoring.

5. The computer implemented method of claim 4, wherein detecting occurrence of the testing process nearing completion comprises executing one or more predefined rules, of a MUT status rules engine, to the status of the testing process in the updated MUT data structure to determine whether results of executing the one or more predefined rules indicates that the testing process is nearing a completion state.

6. The computer-implemented method of claim 1, wherein the operator data in the operator database comprises, for each operator, an operator data structure specifying at least one of machine types and machine models that the operator has handled previous as part of a break team, a number of issues or errors handled by the operator as part of a break team, a total number of frames the operator has assisted with as part of a break team, or a measure of an amount of time that was required to perform break operations for those that the operator was a member of a break team, and wherein the second computer model identifies an eligibility of each of the operators in the operator database based on an evaluation of a corresponding operator data structure.

7. The computer-implemented method of claim 1, wherein the output is an interactive dashboard that outputs a priority listing of MUTs based on a priority output, a specification of which operators are eligible for inclusion in the break team for each MUT in the priority listing, and which operators were selected for inclusion in the break team for the MUT, and wherein a user may interact with the interactive dashboard to modify at least one of the priority listing or the operators selected for inclusion in the break team.

8. The computer-implemented method of claim 7, wherein, in response to a user interacting with the interactive dashboard to modify at least one of the priority listing or the operators selected for inclusion in the break team, sending feedback information to the machine learning computer model specifying the modification and using the modification to re-train the machine learning computer model.

9. The computer-implemented method of claim 1, wherein the output comprises transmitting electronic notifications to communication devices associated with the operators that were selected for the break team.

10. The computer implemented method of claim 1, wherein the MUT is one of a mainframe server computing system or a blade server computing system having multiple blade servers in a server rack, and wherein the test environment is a testing cell of a test floor.

11. A computer program product comprising a computer readable storage medium having a computer readable program stored therein, wherein the computer readable program, when executed on a data processing system, causes the data processing system to:
generate, in response to installing a machine under test (MUT) in a test environment, a MUT data structure in a MUT database that stores machine detail data corresponding to the MUT;
monitor execution of a testing process of the MUT within the testing environment to detect occurrence of the testing process nearing completion; and
in response to detecting that the execution of the testing process is nearing completion:
execute a first computer model on the MUT data structure to prioritize breaking of the MUT from the test environment;
execute a second computer model on operator data in an operator database to identify eligibility of one or more operators to be part of a break team to perform a break out operation on the MUT to break the MUT from the test environment; and
generate an output specifying the break team in association with the MUT and a priority for breaking the MUT from the test environment based on results of the execution of the first computer model and the second computer model.

12. The computer program product of claim 11, wherein executing the second computer model on the operator data in the operator database comprises:
determining, for each operator in a plurality of operators registered in the operator database, a measure of correlation between first skills associated with the operators in the plurality of operators, and second skills required to exit the MUT from the testing environment; and
selecting the one or more operators based on the determined measure of correlation of each of the operators in the plurality of operators.

13. The computer program product of claim 11, wherein the MUT data structure stores MUT characteristic data specifying a machine type, a machine model, a number of frames, and a planned ship date/time, and wherein the first computer model generates a priority measure for the MUT based on the MUT characteristic data.

14. The computer program product of claim 11, wherein monitoring execution of a testing process of the MUT within the testing environment is performed by a test environment status agent executing in the test environment, and wherein the MUT data structure is updated with a status of the testing process based on the monitoring.

15. The computer program product of claim 14, wherein detecting occurrence of the testing process nearing completion comprises executing one or more predefined rules, of a MUT status rules engine, to the status of the testing process in the updated MUT data structure to determine whether results of executing the one or more predefined rules indicates that the testing process is nearing a completion state.

16. The computer program product of claim 11, wherein the operator data in the operator database comprises, for each operator, an operator data structure specifying at least one of machine types and machine models that the operator has handled previous as part of a break team, a number of issues or errors handled by the operator as part of a break team, a total number of frames the operator has assisted with as part of a break team, or a measure of an amount of time that was required to perform break operations for those that the operator was a member of a break team, and wherein the second computer model identifies an eligibility of each of the operators in the operator database based on an evaluation of a corresponding operator data structure.

17. The computer program product of claim 11, wherein the output is an interactive dashboard that outputs a priority listing of MUTs based on a priority output, a specification of which operators are eligible for inclusion in the break team for each MUT in the priority listing, and which operators were selected for inclusion in the break team for the MUT, and wherein a user may interact with the interactive dashboard to modify at least one of the priority listing or the operators selected for inclusion in the break team.

18. The computer program product of claim 17, wherein, in response to a user interacting with the interactive dashboard to modify at least one of the priority listing or the operators selected for inclusion in the break team, sending feedback information to the machine learning computer model specifying the modification and using the modification to re-train the machine learning computer model.

19. The computer program product of claim 11, wherein the output comprises transmitting electronic notifications to communication devices associated with the operators that were selected for the break team.

20. An apparatus comprising:
at least one processor; and
at least one memory coupled to the at least one processor, wherein the at least one memory comprises instructions which, when executed by the at least one processor, cause the at least one processor to:
generate, in response to installing a machine under test (MUT) in a test environment, a MUT data structure in a MUT database that stores machine detail data corresponding to the MUT;
monitor execution of a testing process of the MUT within the testing environment to detect occurrence of the testing process nearing completion; and
in response to detecting that the execution of the testing process is nearing completion:
execute a first computer model on the MUT data structure to prioritize breaking of the MUT from the test environment;
execute a second computer model on operator data in an operator database to identify eligibility of one or more operators to be part of a break team to perform a break out operation on the MUT to break the MUT from the test environment; and
generate an output specifying the break team in association with the MUT and a priority for breaking the MUT from the test environment based on results of the execution of the first computer model and the second computer model.
